(19) United States
(12) Patent Application Publication
(10) Pub. No.: US 2026/0135151 A1
(43) Pub. Date: May 14, 2026

(54) ELECTROLYTE SOLVENTS CONTAINING FLUOROETHYLENE CARBONATE AND NO ETHYLENE CARBONATE

(71) Applicant: Apple Inc., Cupertino, CA (US)

(72) Inventors: Hongli Dai, Los Altos, CA (US); Min Je Park, Cupertino, CA (US); Jongho Jeon, San Jose, CA (US); Zhengcheng Zhang, Naperville, IL (US); Qian Liu, Bolingbrook, IL (US); Ting-Wei Hsu, Bolingbrook, IL (US); James A. Gilbert, Bolingbrook, IL (US)

(21) Appl. No.: 19/379,067

(22) Filed: Nov. 4, 2025

Related U.S. Application Data
(60) Provisional application No. 63/718,957, filed on Nov. 11, 2024.
(60) Provisional application No. 63/718,959, filed on Nov. 11, 2024.

(51) Int. Cl. H01M 10/0569; H01M 10/052; H01M 10/0568

(52) U.S. Cl. CPC H01M 10/0569; H01M 10/052; H01M 10/0568; H01M 2300/0034; H01M 2300/0037

(57) ABSTRACT

This disclosure relates generally to battery cells, and more particularly, electrolyte additives for use in lithium-ion battery cells.

### PRIORITY

This patent application claims the benefit of U.S. Provisional Patent Application No. 63/718,957, entitled “Electrolyte Solvents Containing Fluoroethylene Carbonate and no Ethylene Carbonate”, filed on Nov. 11, 2024, and U.S. Provisional Patent Application No. 63/718,959, entitled “Electrolyte Solvents Containing Fluoroethylene Carbonate and no Ethylene Carbonate”, filed on Nov. 11, 2024, each of which is incorporated herein by reference in its entirety.

### U.S. GOVERNMENT LICENSE RIGHTS

This invention was made with U.S. government support under WFO Proposal No. 85C85 T0 0006. This invention was made under a CRADA 1500801 between Apple Inc. and Argonne National Laboratory operated for the United States Department of Energy. The U.S. government has certain rights in the invention.

### FIELD

This disclosure relates generally to battery cells, and more particularly, electrolyte additives for use in lithium-ion battery cells.

### BACKGROUND

Li-ion batteries are widely used as the power sources in consumer electronics. Consumer electronics include Li-ion batteries which can deliver higher volumetric energy densities and sustain more discharge-charge cycles.

There is a need to alter the composition of electrolyte fluid solvents and additives to provide for improved energy retention, energy capacity, specific discharge capacity, and fast charge cycle life, as well as reduced internal resistance.

### SUMMARY

In a first aspect, the disclosure is directed to an electrolyte fluid including a solvent containing fluoroethylene carbonate (FEC) and no ethylene carbonate (EC).

In some variations, the amount of FEC is 1-45 wt % of the total electrolyte solvent. In further variations, the amount of FEC is 5-25 wt % of the total electrolyte solvent. In some variations, the electrolyte fluid includes a lithium salt selected from LiPF₆, LiBF₄, LiClO₄, LiSO₃CF₃, LiN(SO₂F)₂, LiN(SO₂CF₃)₂, LiBC₄O₈, Li[PF₃(C₂CF₅)₃], LiC(SO₂CF₃)₃, and a combination thereof. In particular variations, the lithium salt is LiPF₆. The lithium salt can be in an amount of 0.1 M-2.0 M in the electrolyte fluid.

In further variations, the electrolyte fluid further includes an additive selected from FEC, methylene methanedisulfonate (MMDS), pro-1-ene-1, 3-sultone (PES), propane sultone (PS), lithium difluoro(oxalato)borate (LiDFOB), succinonitrile (SN), 1,3,6-hexanetricarbonitrile (HTCN), and a combination thereof.

In a second aspect, the electrolyte fluid includes no (0 wt %) PES. In some such variations, the electrolyte fluid includes DFEB, for example, in an amount of 0.03-10 wt %.

In some variations, the electrolyte fluid includes 0.2-2.0 wt % prop-1-ene-1, 3-sultone (PES).

In further variations, the electrolyte fluid includes one or more of 2.0-20.0 wt % FEC, 0-5.0 wt % MMDS, 0.05-12.0 wt % PS, 0.1-5.0 wt % LiDFOB, 0.2-6 wt % wt % SN, 0.3-15 wt % HTCN, or 1.0-3.0 wt % LiBF₄.

In a third aspect, the disclosure is directed to a battery cell. The battery cell includes a cathode comprising a cathode active material disposed on a cathode current collector, an anode comprising an anode active material disposed on an anode current collector such that the anode active material faces the cathode active material, a separator disposed between the cathode active material and the anode active material, and an electrolyte fluid.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 is a top-down view of a battery cell, in accordance with an illustrative embodiment;

FIG. 2 is a perspective view of a battery cell, in accordance with an illustrative embodiment;

FIG. 3 depicts the energy retention as a function of cycle count of battery cells containing Electrolyte Fluid 1, Electrolyte Fluid 2, and Electrolyte Fluid 3, in accordance with illustrative embodiments;

FIG. 4A depicts the energy capacity as a function of cycle count of a battery cell containing three electrolyte fluids at 0.2 discharge capacity, in accordance with illustrative embodiments;

FIG. 4B depicts the energy retention as a function of cycle count of a battery cell containing three electrolyte fluids at 45° C. regular cycle capacity, in accordance with illustrative embodiments;

FIG. 4C depicts the internal resistance (RSS) of three electrolyte fluids, in accordance with illustrative embodiments;

FIG. 4D depicts the specific discharge capacity as a function of cycle count of a battery cell containing three different electrolyte fluids during 4.52V fast charging, in accordance with illustrative embodiments;

FIG. 4E depicts the energy retention as a function of cycle count of a battery cell containing three different electrolyte fluids during 4.52V fast charging, in accordance with illustrative embodiments;

FIG. 5A depicts a comparison of a battery cell that includes electrolyte fluids containing EC and substituting FEC for EC and including 7 wt % Si in a graphite anode, in accordance with illustrative embodiments;

FIG. 5B, depicts the specific capacity of electrolyte fluids containing EC and substituting FEC for EC, in accordance with illustrative embodiments;

FIG. 6A depicts the energy retention as a function of cycle count of battery cells containing three separate electrolyte fluids at 45° C. regular cycle capacity, in accordance with illustrative embodiments;

FIG. 6B depicts the rolling round trip efficiency (RTE) of battery cells containing three separate electrolyte fluids, in accordance with illustrative embodiments;

FIG. 6C depicts the specific discharge capacity of battery cells containing three separate electrolyte fluids, in accordance with illustrative embodiments;

FIG. 6D depicts the 20% state of charge (SOC) RSS resistance of battery cells containing three separate electrolyte fluids, in accordance with illustrative embodiments;

FIG. 6E depicts the rolling RTE20 of battery cells containing three separate electrolyte fluids, in accordance with illustrative embodiments;

FIG. 6F depicts the specific discharge capacity of battery cells containing three separate electrolyte fluids, in accordance with illustrative embodiments; and

FIG. 6G depicts the 0.2 C energy retention as a function of cycle count of battery cells containing three separate electrolyte fluids, in accordance with illustrative embodiments.

### DETAILED DESCRIPTION

Reference will now be made in detail to representative embodiments illustrated in the accompanying drawings. The following descriptions are not intended to limit the embodiments to one preferred embodiment. To the contrary, it is intended to cover alternatives, modifications, and equivalents as can be included within the spirit and scope of the described embodiments as defined by the appended claims.

FIG. 1 presents a top-down view of a battery cell 100 in accordance with an illustrative embodiment. The battery cell 100 may correspond to a lithium-ion or lithium-polymer battery cell that is used to power a device used in a consumer, medical, aerospace, defense, and/or transportation application. The battery cell 100 includes a stack 102 containing a number of layers that include a cathode with a cathode active coating, a separator, and an anode with an anode active coating. More specifically, the stack 102 may include one strip of cathode active material (e.g., aluminum foil coated with a lithium compound) and one strip of anode active material (e.g., copper foil coated with carbon). The stack 102 also includes one strip of separator material (e.g., a microporous polymer membrane or non-woven fabric mat) disposed between the one strip of cathode active material and the one strip of anode active material. The cathode, anode, and separator layers may be left flat in a planar configuration or may be wrapped into a wound configuration (e.g., a “jelly roll”). An electrolyte solution is disposed between the cathode and anode.

During assembly of the battery cell 100, the stack 102 can be enclosed in a pouch or container. The stack 102 may be in a planar or wound configuration, although other configurations are possible. In some variations, the pouch such as a pouch formed by folding a flexible sheet along a fold line 112. In some instances, the flexible sheet is made of aluminum with a polymer film, such as polypropylene. After the flexible sheet is folded, the flexible sheet can be sealed, for example, by applying heat along a side seal 110 and along a terrace seal 108. The flexible pouch may be less than or equal to 120 microns thick to improve the packaging efficiency of the battery cell 100, the density of battery cell 100, or both.

The stack 102 can also include a set of conductive tabs 106 coupled to the cathode and the anode. The conductive tabs 106 may extend through seals in the pouch (for example, formed using sealing tape 104) to provide terminals for the battery cell 100. The conductive tabs 106 may then be used to electrically couple the battery cell 100 with one or more other battery cells to form a battery pack. For example, the battery pack may be formed by coupling the battery cells in a series, parallel, or a series-and-parallel configuration. Such coupled cells may be enclosed in a hard case to complete the battery pack, or may be embedded within an enclosure of a portable electronic device, such as a laptop computer, tablet computer, mobile phone, personal digital assistant (PDA), digital camera, and/or portable media player.

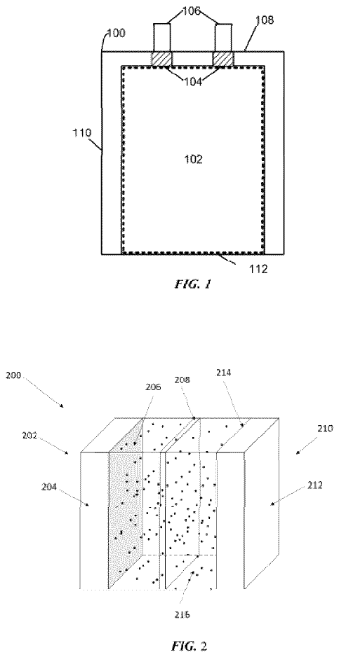

FIG. 2 presents a perspective view of battery cell 200 (e.g., the battery cell 100 of FIG. 1) in accordance with the disclosed illustrative embodiments. The battery includes a cathode 202 that includes current collector 204 and cathode active material 206 and anode 210 including anode current collector 212 and anode active material 214. Separator 208 is disposed between cathode 202 and anode 210. Electrolyte fluid 216 is disposed between cathode 202 and anode 210, and is in contact with separator 208. To create the battery cell, cathode 202, separator 208, and anode 210 may be stacked in a planar configuration, or stacked and then wrapped into a wound configuration. The Electrolyte fluid 216 can then be added. Before assembly of the battery cell, the set of layers may correspond to a cell stack.

The cathode current collector, cathode active material, anode current collector, anode active material, and separator may be any material known in the art. In some variations, the cathode current collector may be an aluminum foil, the anode current collector may be a copper foil.

Any cathode active material known in the art can be used in compositions, battery cells, and methods described herein.

In some variations, the cathode active material is a layered lithium transition metal oxide (LiₓM_{y}O_{z}, M=transition metal element, e.g. Ni, Mn, Co . . . ). Layered lithium transition metal oxides can have compact structures and consequentially high packing densities, high specific volumetric capacity, stable charge/discharge voltages and comparatively good cyclability.

In some further variations, cathode active material includes a compound represented by Formula (I):

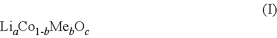

wherein
Me is selected from Na, Si, S, Al, K, V, Cr, Fe, Cu, Zn, Mn, Ni, Zr, La, Ce, Y, Mo, Sn, Ag, Nb, Nu, Ca, Ti, Mg, and a combination thereof,
0.95≤a≤1.05;
0<b≤0.50; and
1.95≤c≤2.05.

In some variations, where Me is a single element selected from Na, Si, S, Al, K, V, Cr, Fe, Cu, Zn, Mn, Ni, Zr, La, Ce, Y, Mo, Sn, Ag, Nb, Nu, Ca, Ti, and Mg, then 0<b≤0.15. In some variations, Me is Mn and Al. In some variations, 0.95≤a≤0.99. In some variations, 0.95≤a≤0.98. In some variations, 0.95≤a≤0.97. In some variations, 0.95≤a≤0.96.

In further variations, Me is more than one element and each separate element present in b is less than or equal to 0.10.

In still further variations, Me is selected from Al, Mn, Ni, Zr, La, Ce, Y, Mo, Sn, Ag, Nb, Ca, Ti, and Mg. The amounts of any element or elements of Me, or selected groups of Me, can be combined with the amount of each element or elements in any combination described herein.

The compound can be any compound described in PCT US2017/052436 or PCT/US2017/022320, both of which are incorporated herein by reference in their entirety.

The cathode active material can be any material, or combination of materials, described in, for example, Ser. Nos. 14/206,654, 15/458,604, 15/458,612, 15/709,961, 15/710,540, 15/804,186, 16/531,883, 16/529,545, 16/999,307, 16/999,328, 16/999,265, and/or 18/798,661, each of which is incorporated herein by reference in its entirety.

In some variations, the anode active material can include carbon, such as graphite or hard carbon. In some variations, the anode active material can include both carbon-based material and silicon. In various aspects, the anode active material can include a binder.

The separator may include a microporous polymer membrane or non-woven fabric mat. Non-limiting examples of the microporous polymer membrane or non-woven fabric mat include microporous polymer membranes or non-woven fabric mats of polyethylene (PE), polypropylene (PP), polyamide (PA), polytetrafluoroethylene (PTFE), polyvinyl chloride (PVC), polyester, and polyvinylidene difluoride (Pad), or a combination thereof. Other microporous polymer membranes or non-woven fabric mats are possible (e.g., gel polymer electrolytes).

In general, separators represent structures in a battery, such as interposed layers, which prevent physical contact of cathodes and anodes while allowing ions to transport therebetween. Separators are formed of materials having pores that provide channels for ion transport, which may include absorbing an electrolyte fluid that contains the ions. Materials for separators may be selected according to chemical stability, porosity, pore size, permeability, wettability, mechanical strength, dimensional stability, softening temperature, and thermal shrinkage. These parameters can influence battery performance and safety during operation.

In general, the electrolyte fluid can act a conductive pathway for the movement of cations passing from the negative to the positive electrodes during discharge. The electrolyte fluid includes an electrolyte salt, a solvent, and one or more electrolyte additives.

### FEC Substituting for EC

Electrolyte fluids described herein contain no EC. Instead of including EC as a solvent component, the electrolyte fluids contain FEC. Battery cells that contain no EC, and in which FEC substitutes for EC, result in higher stability, higher energy retention, and lower RSS as a function of cycle count.

In additional variations, the electrolyte solvent can include PC and EC.

In some variations, FEC is an amount of at least 2 wt % of the total electrolyte fluid. In some variations, FEC is an amount of at least 5 wt % of the total electrolyte fluid. In some variations, FEC is an amount of at least 10 wt % of the total electrolyte fluid. In some variations, FEC is an amount of at least 15 wt % of the total electrolyte fluid. In some variations, FEC is an amount of at least 20 wt % of the total electrolyte fluid. In some variations, FEC is an amount of at least 25 wt % of the total electrolyte fluid.

In some variations, FEC is less than or equal to 30 wt % of the total electrolyte fluid. In some variations, FEC is less than or equal to 25 wt % of the total electrolyte fluid. In some variations, FEC is less than or equal to 20 wt % of the total electrolyte fluid. In some variations, FEC is less than or equal to 15 wt % of the total electrolyte fluid. In some variations, FEC is less than or equal to 10 wt % of the total electrolyte fluid. In some variations, FEC is less than or equal to 5 wt % of the total electrolyte fluid.

The wt % of FEC can have a lower boundary and/or upper boundary in any combination as described herein.

In some variations, PC is an amount of at least 2 wt % of the total electrolyte fluid. In some variations, PC is an amount of at least 5 wt % of the total electrolyte fluid. In some variations, PC is an amount of at least 7 wt % of the total electrolyte fluid. In some variations, PC is an amount of at least 9 wt % of the total electrolyte fluid. In some variations, PC is an amount of at least 11 wt % of the total electrolyte fluid. In some variations, PC is an amount of at least 10 wt % of the total electrolyte fluid. In some variations, PC is an amount of at least 15 wt % of the total electrolyte fluid.

In some variations, PC is less than or equal to 20 wt % of the total electrolyte fluid. In some variations, PC is less than or equal to 15 wt % of the total electrolyte fluid. In some variations, PC is less than or equal to 10 wt % of the total electrolyte fluid. In some variations, PC is less than or equal to 5 wt % of the total electrolyte fluid.

The wt % of PC can have a lower boundary and/or upper boundary in any combination as described herein.

In some variations, EP is an amount of at least 10 wt % of the total electrolyte fluid. In some variations, EP is an amount of at least 15 wt % of the total electrolyte fluid. In some variations, EP is an amount of at least 20 wt % of the total electrolyte fluid. In some variations, EP is an amount of at least 25 wt % of the total electrolyte fluid. In some variations, EP is an amount of at least 30 wt % of the total electrolyte fluid. In some variations, EP is an amount of at least 35 wt % of the total electrolyte fluid. In some variations, EP is an amount of at least 40 wt % of the total electrolyte fluid. In some variations, EP is an amount of at least 45 wt % of the total electrolyte fluid. In some variations, EP is an amount of at least 50 wt % of the total electrolyte fluid. In some variations, EP is an amount of at least 55 wt % of the total electrolyte fluid.

In some variations, EP is less than or equal to 60 wt % of the total electrolyte fluid. In some variations, EP is less than or equal to 55 wt % of the total electrolyte fluid. In some variations, EP is less than or equal to 50 wt % of the total electrolyte fluid. In some variations, EP is less than or equal to 45 wt % of the total electrolyte fluid. In some variations, EP is less than or equal to 40 wt % of the total electrolyte fluid. In some variations, EP is less than or equal to 35 wt % of the total electrolyte fluid. In some variations, EP is less than or equal to 30 wt % of the total electrolyte fluid. In some variations, EP is less than or equal to 25 wt % of the total electrolyte fluid. In some variations, EP is less than or equal to 20 wt % of the total electrolyte fluid. In some variations, EP is less than or equal to 15 wt % of the total electrolyte fluid.

The wt % of EP can have a lower boundary and/or upper boundary in any combination as described herein.

The wt % of EP can have a lower boundary and/or upper boundary in any combination as described herein.

In some variations, PP is an amount of at least 10 wt % of the total electrolyte fluid. In some variations, PP is an amount of at least 15 wt % of the total electrolyte fluid. In some variations, PP is an amount of at least 20 wt % of the total electrolyte fluid. In some variations, PP is an amount of at least 25 wt % of the total electrolyte fluid. In some variations, PP is an amount of at least 30 wt % of the total electrolyte fluid. In some variations, PP is an amount of at least 35 wt % of the total electrolyte fluid. In some variations, PP is an amount of at least 40 wt % of the total electrolyte fluid. In some variations, PP is an amount of at least 45 wt % of the total electrolyte fluid. In some variations, PP is an amount of at least 50 wt % of the total electrolyte fluid. In some variations, PP is an amount of at least 55 wt % of the total electrolyte fluid. In some variations, PP is an amount of at least 60 wt % of the total electrolyte fluid. In some variations, PP is an amount of at least 65 wt % of the total electrolyte fluid. In some variations, PP is an amount of at least 70 wt % of the total electrolyte fluid. In some variations, PP is an amount of at least 75 wt % of the total electrolyte fluid.

In some variations, PP is less than or equal to 80 wt % of the total electrolyte fluid. In some variations, PP is less than or equal to 75 wt % of the total electrolyte fluid. In some variations, PP is less than or equal to 70 wt % of the total electrolyte fluid. In some variations, PP is less than or equal to 65 wt % of the total electrolyte fluid. In some variations, PP is less than or equal to 60 wt % of the total electrolyte fluid. In some variations, PP is less than or equal to 55 wt % of the total electrolyte fluid. In some variations, PP is less than or equal to 50 wt % of the total electrolyte fluid. In some variations, PP is less than or equal to 45 wt % of the total electrolyte fluid. In some variations, PP is less than or equal to 40 wt % of the total electrolyte fluid. In some variations, PP is less than or equal to 35 wt % of the total electrolyte fluid. In some variations, PP is less than or equal to 30 wt % of the total electrolyte fluid. In some variations, PP is less than or equal to 25 wt % of the total electrolyte fluid. In some variations, PP is less than or equal to 20 wt % of the total electrolyte fluid. In some variations, PP is less than or equal to 15 wt % of the total electrolyte fluid.

The wt % of PP can have a lower boundary and/or upper boundary in any combination as described herein.

In some variations, dimethyl carbonate (DMC) and ethylmethylcarbonate (EMC) can be substituted for EP and PP. The addition of DMC and EMC to the electrolyte solvent can result in increased discharge capacity, increased energy retention, and reduced internal resistance, particularly at increased cycle counts.

The combined quantity of DMC and EMC can have a lower boundary and/or an upper boundary. In one variation, the combined quantity of DMC and EMC is at least 50% of the total electrolyte fluid. In another variation, the combined quantity of DMC and EMC is at least 55% of the total electrolyte fluid. In another variation, the combined quantity of DMC and EMC is at least 60% of the total electrolyte fluid. In another variation, the combined quantity of DMC and EMC is at least 65% of the total electrolyte fluid. In another variation, the combined quantity of DMC and EMC is at least 70% of the total electrolyte fluid. In another variation, the combined quantity of DMC and EMC is at least 75% of the total electrolyte fluid.

In another variation, the combined quantity of DMC and EMC is less than or equal to 80 wt % of the total electrolyte fluid. In another variation, the combined quantity of DMC and EMC is less than or equal to 80 wt % of the total electrolyte fluid. In another variation, the combined quantity of DMC and EMC is less than or equal to 75 wt % of the total electrolyte fluid. In another variation, the combined quantity of DMC and EMC is less than or equal to 70 wt % of the total electrolyte fluid. In another variation, the combined quantity of DMC and EMC is less than or equal to 65 wt % of the total electrolyte fluid. In another variation, the combined quantity of DMC and EMC is less than or equal to 60 wt % of the total electrolyte fluid. In another variation, the combined quantity of DMC and EMC is less than or equal to 55 wt % of the total electrolyte fluid.

The combined quantity of DMC and EMC can have a lower boundary and/or upper boundary in any combination. In some variations, the combined quantity of DMC and EMC is 50 wt %-80 wt % of the electrolyte fluid.

In one variation, the wt % ratio of DMC:EMC is at least 1:4. In one variation, the wt % ratio of DMC:EMC is at least 1:3. In another variation, the wt % ratio of DMC:EMC is at least 1:2. In another variation, the wt % ratio of DMC:EMC is at least 1:1. In one variation, the wt % ratio of DMC:EMC is at least 2:1. In another variation, the wt % ratio of DMC:EMC is at least 3:1.

In other variations, the wt % ratio of DMC:EMC is less than or equal to 4:1. In another variation, the wt % ratio of DMC:EMC is less than or equal to 3:1. In another variation, the wt % ratio of DMC:EMC is less than or equal to 2:1. In another variation, the wt % ratio of DMC:EMC is less than or equal to 1:1. In another variation, the wt % ratio of DMC:EMC is less than or equal to 1:2. In another variation, the wt % ratio of DMC:EMC is less than or equal to 1:3.

The wt % ratio of DMC:EMC can have a lower boundary and/or upper boundary in any combination. In one variation, the wt % ratio of DMC:EMC is from 1:4::4:1.

In some variations, DMC is an amount of at least 10 wt % of the total electrolyte fluid. In some variations, DMC is an amount of at least 20 wt % of the total electrolyte fluid. In some variations, DMC is an amount of at least 30 wt % of the total electrolyte fluid. In some variations, DMC is an amount of at least 40 wt % of the total electrolyte fluid. In some variations, DMC is an amount of at least 50 wt % of the total electrolyte fluid. In some variations, DMC is an amount of at least 60 wt % of the total electrolyte fluid.

In some variations, DMC is less than or equal to 70 wt % of the total electrolyte fluid. In some variations, DMC is less than or equal to 60 wt % of the total electrolyte fluid. In some variations, DMC is less than or equal to 50 wt % of the total electrolyte fluid. In some variations, DMC is less than or equal to 40 wt % of the total electrolyte fluid. In some variations, DMC is less than or equal to 30 wt % of the total electrolyte fluid. In some variations, DMC is less than or equal to 20 wt % of the total electrolyte fluid.

The wt % of DMC can have a lower boundary and/or upper boundary in any combination as described herein.

In some variations, EMC is an amount of at least 10 wt % of the total electrolyte fluid. In some variations, EMC is an amount of at least 20 wt % of the total electrolyte fluid. In some variations, EMC is an amount of at least 30 wt % of the total electrolyte fluid. In some variations, EMC is an amount of at least 40 wt % of the total electrolyte fluid. In some variations, EMC is an amount of at least 50 wt % of the total electrolyte fluid. In some variations, EMC is an amount of at least 60 wt % of the total electrolyte fluid.

In some variations, EMC is less than or equal to 70 wt % of the total electrolyte fluid. In some variations, EMC is less than or equal to 60 wt % of the total electrolyte fluid. In some variations, EMC is less than or equal to 50 wt % of the total electrolyte fluid. In some variations, EMC is less than or equal to 40 wt % of the total electrolyte fluid. In some variations, EMC is less than or equal to 30 wt % of the total electrolyte fluid. In some variations, EMC is less than or equal to 20 wt % of the total electrolyte fluid.

The wt % of EMC can have a lower boundary and/or upper boundary in any combination as described herein.

### PES

In some variations, the electrolyte fluid has at least 0.2 wt % PES. In some variations, the electrolyte fluid has at least 0.4 wt % PES. In some variations, the electrolyte fluid has at least 0.6 wt % PES. In some variations, the electrolyte fluid has at least 0.8 wt % PES. In some variations, the electrolyte fluid has at least 1.2 wt % PES. In some variations, the electrolyte fluid has at least 1.4 wt % PES. In some variations, the electrolyte fluid has at least 1.6 wt % PES. In some variations, the electrolyte fluid has at least 1.8 wt % PES.

In some variations, the electrolyte fluid has less than or equal to 2.0 wt % PES. In some variations, the electrolyte fluid has less than or equal to 1.8 wt % PES. In some variations, the electrolyte fluid has less than or equal to 1.6 wt % PES. In some variations, the electrolyte fluid has less than or equal to 1.4 wt % PES. In some variations, the electrolyte fluid has less than or equal to 1.2 wt % PES. In some variations, the electrolyte fluid has less than or equal to 1.0 wt % PES. In some variations, the electrolyte fluid has less than or equal to 0.8 wt % PES. In some variations, the electrolyte fluid has less than or equal to 0.6 wt % PES. In some variations, the electrolyte fluid has less than or equal to 0.4 wt % PES.

In some particular variations, the electrolyte fluid has 0.2-2.0 wt % PES.

In still further variations, the electrolyte fluid has 0 wt % PES.

Tris(2,2-difluoroethyl)borate (DFEB)

In some variations, the electrolyte fluid can include DFEB.

In some variations, the electrolyte fluid has at least 0.2 wt % DFEB. In some variations, the electrolyte fluid has at least 0.4 wt % DFEB. In some variations, the electrolyte fluid has at least 0.6 wt % DFEB. In some variations, the electrolyte fluid has at least 0.8 wt % DFEB. In some variations, the electrolyte fluid has at least 1.2 wt % DFEB. In some variations, the electrolyte fluid has at least 1.4 wt % DFEB. In some variations, the electrolyte fluid has at least 1.6 wt % DFEB. In some variations, the electrolyte fluid has at least 1.8 wt % DFEB.

In some variations, the electrolyte fluid has less than or equal to 2.0 wt % DFEB. In some variations, the electrolyte fluid has less than or equal to 1.8 wt % DFEB. In some variations, the electrolyte fluid has less than or equal to 1.6 wt % DFEB. In some variations, the electrolyte fluid has less than or equal to 1.4 wt % DFEB. In some variations, the electrolyte fluid has less than or equal to 1.2 wt % DFEB. In some variations, the electrolyte fluid has less than or equal to 1.0 wt % DFEB. In some variations, the electrolyte fluid has less than or equal to 0.8 wt % DFEB. In some variations, the electrolyte fluid has less than or equal to 0.6 wt % DFEB. In some variations, the electrolyte fluid has less than or equal to 0.4 wt % DFEB.

In some particular variations, the electrolyte fluid has 0.2-2.0 wt % DFEB.

### Ethoxy(pentafluoro)cyclotriphosphazene (EFPN)

In combination with electrolyte fluids containing no EC and including FEC as a solvent, the addition of EFPN as an electrolyte fluid additive provides improved battery cell performance.

EFPN has the chemical formula of Formula (II):

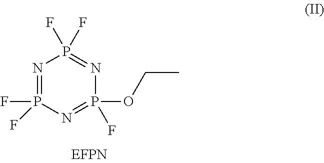

Formula (II) is also referred to herein as EFPN. EFPN is a bi-functional additive that reduces the graphite solid electrolyte interphase (SEI) interface resistance and improves cathode electrolyte interphase (CEI) stability, leading to improved cell fast charging and longevity performance. In addition, EFPN is fire retardant.

In some variations, the electrolyte fluid includes at least 0.01 wt % EFPN. In some variations, the electrolyte fluid includes at least 0.05 wt % EFPN. In some variations, the electrolyte fluid includes at least 0.10 wt % EFPN. In some variations, the electrolyte fluid includes at least 0.50 wt % EFPN. In some variations, the electrolyte fluid includes at least 1.0 wt % EFPN. In some variations, the electrolyte fluid includes at least 1.5 wt % EFPN. In some variations, the electrolyte fluid includes at least 2.5 wt % EFPN. In some variations, the electrolyte fluid includes less than or equal to 3.0 wt % EFPN. In some variations, the electrolyte fluid includes less than or equal to 2.75 wt % EFPN. In some variations, the electrolyte fluid includes less than or equal to 2.5 wt % EFPN. In some variations, the electrolyte fluid includes less than or equal to 2.25 wt % EFPN. In some variations, the electrolyte fluid includes less than or equal to 2.0 wt % EFPN. In some variations, the electrolyte fluid includes less than or equal to 1.5 wt % EFPN. In some variations, the electrolyte fluid includes less than or equal to 1.0 wt % EFPN. In some variations, the electrolyte fluid includes less than or equal to 0.75 wt % EFPN. In some variations, the electrolyte fluid includes less than or equal to 0.50 wt % EFPN. In some variations, the electrolyte fluid includes less than or equal to 0.25 wt % EFPN. In some variations, the electrolyte fluid includes less than or equal to 0.10 wt % EFPN.

### Additional Additives

In some variations, additional FEC can be added as an additive (in addition to as a solvent). In various aspects, herein, FEC can be used as both a solvent and an additive. As referred to herein, the concentration of lithium salts is based on the volume of solvent mixture. The amount of additives as disclosed herein are based on the wt % of the solvent and lithium salts.

In some variations, the electrolyte fluid can include FEC. In some variations, the amount of FEC is at least 0.5 wt % of the total electrolyte fluid. In some variations, the amount of FEC is at least 1.5 wt % of the total electrolyte fluid. In some variations, the amount of FEC is at least 2.0 wt % of the total electrolyte fluid. In some variations, the amount of FEC is at least 2.5 wt % of the total electrolyte fluid. In some variations, the amount of FEC is at least 3.0 wt % of the total electrolyte fluid. In some variations, the amount of FEC is at least 3.5 wt % of the total electrolyte fluid. In some variations, the amount of FEC is at least 4.0 wt % of the total electrolyte fluid. In some variations, the amount of FEC is at least 4.5 wt % of the total electrolyte fluid. In some variations, the amount of FEC is at least 5.0 wt % of the total electrolyte fluid. In some variations, the amount of FEC is at least 5.5 wt % of the total electrolyte fluid. In some variations, the amount of FEC is at least 6.5 wt % of the total electrolyte fluid. In some variations, the amount of FEC is at least 7.0 wt % of the total electrolyte fluid. In some variations, the amount of FEC is at least 7.5 wt % of the total electrolyte fluid. In some variations, the amount of FEC is at least 8.0 wt % of the total electrolyte fluid. In some variations, the amount of FEC is at least 8.5 wt % of the total electrolyte fluid. In some variations, the amount of FEC is at least 9.0 wt % of the total electrolyte fluid. In some variations, the amount of FEC is at least 9.5 wt % of the total electrolyte fluid. In some variations, the amount of FEC is at least 10.0 wt % of the total electrolyte fluid. In some variations, the amount of FEC is at least 10.5 wt % of the total electrolyte fluid. In some variations, the amount of FEC is at least 11.0 wt % of the total electrolyte fluid. In some variations, the amount of FEC is at least 11.5 wt % of the total electrolyte fluid. In some variations, the amount of FEC is at least 11.0 wt % of the total electrolyte fluid. In some variations, the amount of FEC is at least 11.5 wt % of the total electrolyte fluid. In some variations, the amount of FEC is at least 12.0 wt % of the total electrolyte fluid. In some variations, the amount of FEC is at least 12.5 wt % of the total electrolyte fluid. In some variations, the amount of FEC is at least 13.0 wt % of the total electrolyte fluid. In some variations, the amount of FEC is at least 13.5 wt % of the total electrolyte fluid. In some variations, the amount of FEC is at least 14.0 wt % of the total electrolyte fluid. In some variations, the amount of FEC is at least 14.5 wt % of the total electrolyte fluid. In some variations, the amount of FEC is at least 15.0 wt % of the total electrolyte fluid. In some variations, the amount of FEC is at least 16.0 wt % of the total electrolyte fluid. In some variations, the amount of FEC is at least 17.0 wt % of the total electrolyte fluid.

In some variations, the amount of FEC is less than or equal to 18.0 wt % of the total electrolyte fluid. In some variations, the amount of FEC is less than or equal to 17.0 wt % of the total electrolyte fluid. In some variations, the amount of FEC is less than or equal to 16.0 wt % of the total electrolyte fluid. In some variations, the amount of FEC is less than or equal to 15.5 wt % of the total electrolyte fluid. In some variations, the amount of FEC is less than or equal to 15.0 wt % of the total electrolyte fluid. In some variations, the amount of FEC is less than or equal to 14.5 wt % of the total electrolyte fluid. In some variations, the amount of FEC is less than or equal to 14.0 wt % of the total electrolyte fluid. In some variations, the amount of FEC is less than or equal to 13.5 wt % of the total electrolyte fluid. In some variations, the amount of FEC is less than or equal to 13.0 wt % of the total electrolyte fluid. In some variations, the amount of FEC is less than or equal to 12.5 wt % of the total electrolyte fluid. In some variations, the amount of FEC is less than or equal to 12.0 wt % of the total electrolyte fluid. In some variations, the amount of FEC is less than or equal to 11.5 wt % of the total electrolyte fluid. In some variations, the amount of FEC is less than or equal to 11.0 wt % of the total electrolyte fluid. In some variations, the amount of FEC is less than or equal to 10.5 wt % of the total electrolyte fluid. In some variations, the amount of FEC is less than or equal to 10.0 wt % of the total electrolyte fluid. In some variations, the amount of FEC is less than or equal to 9.5 wt % of the total electrolyte fluid. In some variations, the amount of FEC is less than or equal to 9.0 wt % of the total electrolyte fluid. In some variations, the amount of FEC is less than or equal to 8.5 wt % of the total electrolyte fluid. In some variations, the amount of FEC is less than or equal to 8.0 wt % of the total electrolyte fluid. In some variations, the amount of FEC is less than or equal to 7.5 wt % of the total electrolyte fluid. In some variations, the amount of FEC is less than or equal to 7.0 wt % of the total electrolyte fluid. In some variations, the amount of FEC is less than or equal to 6.5 wt % of the total electrolyte fluid. In some variations, the amount of FEC is less than or equal to 6.0 wt % of the total electrolyte fluid. In some variations, the amount of FEC is less than or equal to 5.5 wt % of the total electrolyte fluid. In some variations, the amount of FEC is less than or equal to 5.0 wt % of the total electrolyte fluid. In some variations, the amount of FEC is less than or equal to 4.5 wt % of the total electrolyte fluid. In some variations, the amount of FEC is less than or equal to 4.0 wt % of the total electrolyte fluid. In some variations, the amount of FEC is less than or equal to 3.5 wt % of the total electrolyte fluid. In some variations, the amount of FEC is less than or equal to 3.0 wt % of the total electrolyte fluid. In some variations, the amount of FEC is less than or equal to 2.5 wt % of the total electrolyte fluid. In some variations, the amount of FEC is less than or equal to 2.0 wt % of the total electrolyte fluid. In some variations, the amount of FEC is less than or equal to 1.5 wt % of the total electrolyte fluid. In some variations, the amount of FEC is less than or equal to 1.0 wt % of the total electrolyte fluid.

FEC can be present in a lower boundary, upper boundary, or both. The upper and lower boundaries of the FEC quantity as described herein can be chosen in any combination.

In some variations, the electrolyte fluid can include MMDS. In some variations, MMDS is at least 1 wt % of the total electrolyte fluid. In some variations, MMDS is at least 2.0 wt % of the total electrolyte fluid. In some variations, MMDS is at least 3.0 wt % of the total electrolyte fluid. In some variations, MMDS is at least 4.0 wt % of the total electrolyte fluid.

In some variations, MMDS is less than or equal to 5.0 wt % of the total electrolyte fluid. In some variations, MMDS is less than or equal to 4.0 wt % of the total electrolyte fluid. In some variations, MMDS is less than or equal to 3.0 wt % of the total electrolyte fluid. In some variations, MMDS is less than or equal to 2.0 wt % of the total electrolyte fluid.

In some variations, the electrolyte fluid can include LiDFOB. In some variations, LiDFOB is at least 0.1 wt % of the total electrolyte fluid. In some variations, LiDFOB is at least 0.2 wt % of the total electrolyte fluid. In some variations, LiDFOB is at least 0.3 wt % of the total electrolyte fluid. In some variations, LiDFOB is at least 0.4 wt % of the total electrolyte fluid. In some variations, LiDFOB is at least 0.5 wt % of the total electrolyte fluid. In some variations, LiDFOB is at least 0.6 wt % of the total electrolyte fluid. In some variations, LiDFOB is at least 0.7 wt % of the total electrolyte fluid. In some variations, LiDFOB is at least 0.8 wt % of the total electrolyte fluid. In some variations, LiDFOB is at least 0.9 wt % of the total electrolyte fluid. In some variations, LiDFOB is at least 1.0 wt % of the total electrolyte fluid. In some variations, LiDFOB is at least 1.3 wt % of the total electrolyte fluid. In some variations, LiDFOB is at least 1.6 wt % of the total electrolyte fluid. In some variations, LiDFOB is at least 1.9 wt % of the total electrolyte fluid. In some variations, LiDFOB is at least 2.0 wt % of the total electrolyte fluid. In some variations, LiDFOB is at least 2.3 wt % of the total electrolyte fluid. In some variations, LiDFOB is at least 2.6 wt % of the total electrolyte fluid. In some variations, LiDFOB is at least 2.9 wt % of the total electrolyte fluid.

In some variations, LiDFOB is less than or equal to 3.0 wt % of the total electrolyte fluid. In some variations, LiDFOB is less than or equal to 2.9 wt % of the total electrolyte fluid. In some variations, LiDFOB is less than or equal to 2.6 wt % of the total electrolyte fluid. In some variations, LiDFOB is less than or equal to 2.3 wt % of the total electrolyte fluid. In some variations, LiDFOB is less than or equal to 2.0 wt % of the total electrolyte fluid. In some variations, LiDFOB is less than or equal to 1.9 wt % of the total electrolyte fluid. In some variations, LiDFOB is less than or equal to 1.3 wt % of the total electrolyte fluid. In some variations, LiDFOB is less than or equal to 1.3 wt % of the total electrolyte fluid. In some variations, LiDFOB is less than or equal to 1.1 wt % of the total electrolyte fluid. In some variations, LiDFOB is less than or equal to 1.0 wt % of the total electrolyte fluid. In some variations, LiDFOB is less than or equal to 0.9 wt % of the total electrolyte fluid. In some variations, LiDFOB is less than or equal to 0.8 wt % of the total electrolyte fluid. In some variations, LiDFOB is less than or equal to 0.7 wt % of the total electrolyte fluid. In some variations, LiDFOB is less than or equal to 0.6 wt % of the total electrolyte fluid. In some variations, LiDFOB is less than or equal to 0.5 wt % of the total electrolyte fluid. In some variations, LiDFOB is less than or equal to 0.4 wt % of the total electrolyte fluid. In some variations, LiDFOB is less than or equal to 0.3 wt % of the total electrolyte fluid. In some variations, LiDFOB is less than or equal to 0.2 wt % of the total electrolyte fluid.

LiDFOB can be present in a lower boundary, upper boundary, or both. The upper and lower boundaries of the LiDFOB quantity as described herein can be chosen in any combination.

In some variations, the amount of SN is at least 0.05 wt % of the total electrolyte fluid. In some variations, the amount of SN is at least 0.10 wt % of the total electrolyte fluid. In some variations, the amount of SN is at least 0.15 wt % of the total electrolyte fluid. In some variations, the amount of SN is at least 0.20 wt % of the total electrolyte fluid. In some variations, the amount of SN is at least 0.25 wt % of the total electrolyte fluid. In some variations, the amount of SN is at least 0.30 wt % of the total electrolyte fluid. In some variations, the amount of SN is at least 0.35 wt % of the total electrolyte fluid. In some variations, the amount of SN is at least 0.40 wt % of the total electrolyte fluid. In some variations, the amount of SN is at least 0.45 wt % of the total electrolyte fluid.

In some variations, the amount of SN is less than or equal to 0.50 wt % of the total electrolyte fluid. In some variations, the amount of SN is less than or equal to 0.45 wt % of the total electrolyte fluid. In some variations, the amount of SN is less than or equal to 0.40 wt % of the total electrolyte fluid. In some variations, the amount of SN is less than or equal to 0.35 wt % of the total electrolyte fluid. In some variations, the amount of SN is less than or equal to 0.30 wt % of the total electrolyte fluid. In some variations, the amount of SN is less than or equal to 0.25 wt % of the total electrolyte fluid. In some variations, the amount of SN is less than or equal to 0.20 wt % of the total electrolyte fluid. In some variations, the amount of SN is less than or equal to 0.15 wt % of the total electrolyte fluid. In some variations, the amount of SN is less than or equal to 0.10 wt % of the total electrolyte fluid.

SN can be present in a lower boundary, upper boundary, or both. The upper and lower boundaries of the SN quantity as described herein can be chosen in any combination.

In some variations, the amount of PS is at least 0.5 wt % of the total electrolyte fluid. In some variations, the amount of PS is at least 1.0 wt % of the total electrolyte fluid. In some variations, the amount of PS is at least 1.5 wt % of the total electrolyte fluid. In some variations, the amount of PS is at least 2.0 wt % of the total electrolyte fluid. In some variations, the amount of PS is at least 2.5 wt % of the total electrolyte fluid. In some variations, the amount of PS is at least 3.0 wt % of the total electrolyte fluid. In some variations, the amount of PS is at least 3.5 wt % of the total electrolyte fluid. In some variations, the amount of PS is at least 4.0 wt % of the total electrolyte fluid. In some variations, the amount of PS is at least 4.5 wt % of the total electrolyte fluid. In some variations, the amount of PS is at least 5.0 wt % of the total electrolyte fluid. In some variations, the amount of PS is at least 5.5 wt % of the total electrolyte fluid. In some variations, the amount of PS is at least 6.0 wt % of the total electrolyte fluid. In some variations, the amount of PS is at least 6.5 wt % of the total electrolyte fluid. In some variations, the amount of PS is at least 7.0 wt % of the total electrolyte fluid. In some variations, the amount of PS is at least 7.5 wt % of the total electrolyte fluid.

In some variations, the amount of PS is less than or equal to 8.0 wt % of the total electrolyte fluid. In some variations, the amount of PS is less than or equal to 7.5 wt % of the total electrolyte fluid. In some variations, the amount of PS is less than or equal to 7.0 wt % of the total electrolyte fluid. In some variations, the amount of PS is less than or equal to 6.5 wt % of the total electrolyte fluid. In some variations, the amount of PS is less than or equal to 6.0 wt % of the total electrolyte fluid. In some variations, the amount of PS is less than or equal to 5.5 wt % of the total electrolyte fluid. In some variations, the amount of PS is less than or equal to 5.0 wt % of the total electrolyte fluid. In some variations, the amount of PS is less than or equal to 4.5 wt % of the total electrolyte fluid. In some variations, the amount of PS is less than or equal to 4.0 wt % of the total electrolyte fluid. In some variations, the amount of PS is less than or equal to 3.5 wt % of the total electrolyte fluid. In some variations, the amount of PS is less than or equal to 3.0 wt % of the total electrolyte fluid. In some variations, the amount of PS is less than or equal to 2.5 wt % of the total electrolyte fluid. In some variations, the amount of PS is less than or equal to 2.0 wt % of the total electrolyte fluid. In some variations, the amount of PS is less than or equal to 1.5 wt % of the total electrolyte fluid. In some variations, the amount of PS is less than or equal to 1.0 wt % of the total electrolyte fluid.

PS can be present in a lower boundary, upper boundary, or both. The upper and lower boundaries of the PS quantity as described herein can be chosen in any combination.

In some variations, the amount of HTCN is at least 0.5 wt % of the total electrolyte fluid. In some variations, the amount of HTCN is at least 1.0 wt % of the total electrolyte fluid. In some variations, the amount of HTCN is at least 1.5 wt % of the total electrolyte fluid. In some variations, the amount of HTCN is at least 2.0 wt % of the total electrolyte fluid. In some variations, the amount of HTCN is at least 2.5 wt % of the total electrolyte fluid. In some variations, the amount of HTCN is at least 3.0 wt % of the total electrolyte fluid. In some variations, the amount of HTCN is at least 3.5 wt % of the total electrolyte fluid. In some variations, the amount of HTCN is at least 4.0 wt % of the total electrolyte fluid. In some variations, the amount of HTCN is at least 4.5 wt % of the total electrolyte fluid. In some variations, the amount of HTCN is at least 5.0 wt % of the total electrolyte fluid.

In some variations, the amount of HTCN is less than or equal to 6.0 wt % of the total electrolyte fluid. In some variations, the amount of HTCN is less than or equal to 5.5 wt % of the total electrolyte fluid. In some variations, the amount of HTCN is less than or equal to 5.0 wt % of the total electrolyte fluid. In some variations, the amount of HTCN is less than or equal to 4.5 wt % of the total electrolyte fluid. In some variations, the amount of HTCN is less than or equal to 4.0 wt % of the total electrolyte fluid. In some variations, the amount of HTCN is less than or equal to 3.5 wt % of the total electrolyte fluid. In some variations, the amount of HTCN is less than or equal to 3.0 wt % of the total electrolyte fluid. In some variations, the amount of HTCN is less than or equal to 2.5 wt % of the total electrolyte fluid. In some variations, the amount of HTCN is less than or equal to 2.0 wt % of the total electrolyte fluid. In some variations, the amount of HTCN is less than or equal to 1.5 wt % of the total electrolyte fluid. In some variations, the amount of HTCN is less than or equal to 1.0 wt % of the total electrolyte fluid.

HTCN can be present in a lower boundary, upper boundary, or both. The upper and lower boundaries of the HTCN quantity as described herein can be chosen in any combination.

In some variations, the electrolyte fluid can include LiBF₄. In some variations, LiBF₄ is at least 1 wt % of the total electrolyte fluid. In some variations, LiBF₄ is at least 2.0 wt % of the total electrolyte fluid. In some variations, LiBF₄ is less than or equal to 3.0 wt % of the total electrolyte fluid. In some variations, LiBF₄ is less than or equal to 2.0 wt % of the total electrolyte fluid. LiBF₄ can be present in a lower boundary, upper boundary, or both. The upper and lower boundaries of the LiBF₄ quantity as described herein can be chosen in any combination.

### EXAMPLES

The Examples are provided for illustration purposes only. These examples are not intended to constrain any embodiment disclosed herein to any application or theory of operation.

### Example 1

As depicted in Table 1, Electrolyte Fluid 1 includes a solvent having EC, PC, EP, and PP. Electrolyte Fluid 2 also has EC (15 wt %). Electrolyte Fluid 3 substitutes FEC solvent (15 wt %) for EC of Electrolyte Fluid 2. Electrolyte Fluid 3 has no EC (0 wt % EC). The total FEC of Electrolyte 3 totals 23 wt %, including both as a solvent and an additive. As depicted in Table 2, the storage stability does not change between electrolyte fluids with and without EC (i.e., substituting FEC solvent component for the EC solvent component).

TABLE 1

| | Solvent (wt %) | LiPF6 | FEC | MMDS | PES | PS | LiDFOB | SN | HTCN |
|---|---|---|---|---|---|---|---|---|---|
| Electrolyte | EC/PC/EP/PP | 1.2M | 7.0 | 0.5 | 1.5 | 2.5 | 0.7 | 2.0 | 3.0 |
| Fluid 1 | 20:10:25:45 | | | | | | | | |
| Electrolyte | EC/PC/EP/PP | 1.2M | 8.0 | | 0.7 | 4.0 | 1.0 | 2.0 | 3.0 |
| Fluid 2 | 15:5:30:50 | | | | | | | | |
| Electrolyte | FEC/PC/EP/PP | 1.2M | 8.0 | | 0.7 | 4.0 | 1.0 | 2.0 | 3.0 |
| Fluid 3 | 15:5:30:50 | | | | | | | | |

TABLE 2

| | | | | | 25° C. ATV 4.2 |
|---|---|---|---|---|---|
| | | | | 85° C. 8 hrs | ER at CLS |
| | | 85° C. 8 hrs | 85° C. 8 hrs | storage | 200, % |
| | Solvent | storage swell | storage swell | recovery | (20 min to |
| | (wt %) | (T2), mm | (T2/T0), % | capacity, % | 50% SOC) |
| Electrolyte | EC/PC/EP/PP | 4.148 ± 0.024 | 7.27 ± 0.34 | 91.43 ± 0.39 | 96 ± 0.74 |
| 1 | 20:10:25:45 | | | | |
| Electrolyte | EC/PC/EP/PP | 4.114 ± 0.014 | 5.62 ± 0.11 | 91.89 ± 0.12 | 97.66 ± 1.21 |
| 2 | 15:5:30:50 | | | | |
| Electrolyte | FEC/PC/EP/PP | 4.13 ± 0.025 | 5.65 ± 0.52 | 92.52 ± 0.19 | 97.54 ± 0.96 |
| 3 | 15:5:30:50 | | | | |

Generally, Electrolyte 3 in which FEC substitutes EC showed higher stability, higher energy retention, and lower RSS.

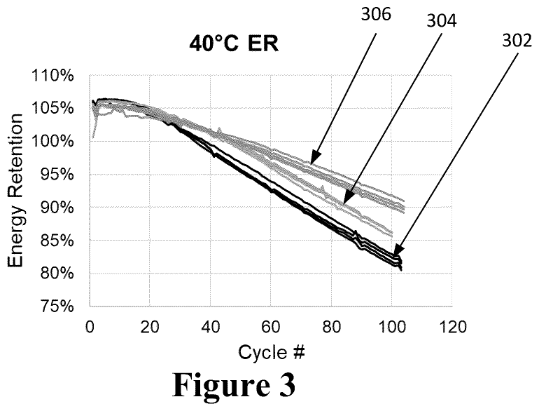

FIG. 3 depicts the energy retention as a function of cycle count of battery cells containing Electrolyte Fluid 1 (302), Electrolyte Fluid 2 (304), and Electrolyte Fluid 3 (306) at 40° C. operated at 4.50V multi-layer pouch (MLP) for accelerated cycle per day (ACPD). By eliminating EC and substituting FEC, energy retention as a function of cycle count of the battery cell improved.

Table 3 shows three electrolyte fluids. None of the electrolyte fluids include EC as a solvent or an additive. Electrolyte Fluid 3 includes PES. In Electrolyte Fluid 4 and Electrolyte Fluid 5, no PES additive is included. Electrolyte Fluid 5 includes DFEB.

TABLE 3

| UCV | Electrolyte | | Salt | Additive | | | | | | |
|---|---|---|---|---|---|---|---|---|---|---|
| (V) | Fluid | Solvent | LiPF6 | FEC | PES | PS | LiDFOB | SN | HTCN | DFEB |
| 4.52 | Electrolyte | FEC/EC/PC/EP/PP | 1.2M | 8 | 0.7 | 4 | 1 | 2 | 3 | |
| | Fluid 3 | 15:0:5:30:50 | | | | | | | | |
| 4.52 | Electrolyte | FEC/EC/PC/EP/PP | 1.2M | 8 | | 4 | 1 | 2 | 3 | |
| | Fluid 4 | 15:0:5:30:50 | | | | | | | | |
| 4.52 | Electrolyte | FEC/EC/PC/EP/PP | 1.2M | 8 | | 4 | 1 | 2 | 3 | 0.3 |
| | Fluid 5 | 15:0:5:30:50 | | | | | | | | |

### Example 2

As depicted in Table 4, Electrolyte Fluids 3, 4, and 5 all have the same storage stability measurements.

TABLE 4

| | | | 45° C. | 45° C. | | |
|---|---|---|---|---|---|---|
| | | | ACPD 1^{st} | ACPD 2^{nd} | 25° C. | 25° C. |
| | | | Cycle | Cycle | Formation | Formation |
| | | | capacity, | RSS, | capacity, | RSS, |
| UCV | EL Code | Solvent | mAh/g | Ω cm² | mAh/g | Ω cm² |
| 4.52 | Electrolyte | FEC/EC/PC/EP/PP | 195.3 ± 0.1 | 29.8 ± 0.6 | 189.8 ± 0.2 | 69.5 ± 1.0 |
| | Fluid 3 | 15:0:5:30:50 | | | | |
| 4.52 | Electrolyte | FEC/EC/PC/EP/PP | 195.1 ± 0.2 | 28.3 ± 0.2 | 189.7 ± 0.4 | 65.5 ± 1.4 |
| | Fluid 4 | 15:0:5:30:50 | | | | |
| 4.52 | Electrolyte | FEC/EC/PC/EP/PP | 195.0 ± 0.1 | 25.3 ± 2.2 | 189.3 ± 0.4 | 63.1 ± 1.6 |
| | Fluid 5 | 15:0:5:30:50 | | | | |

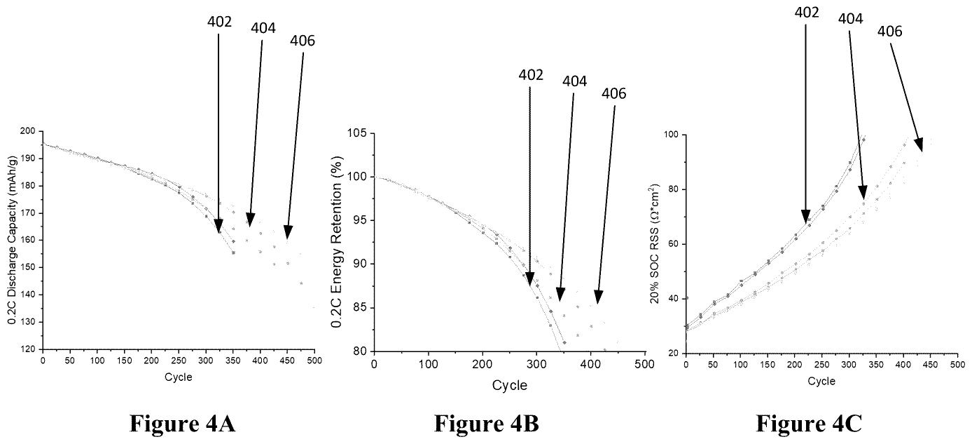

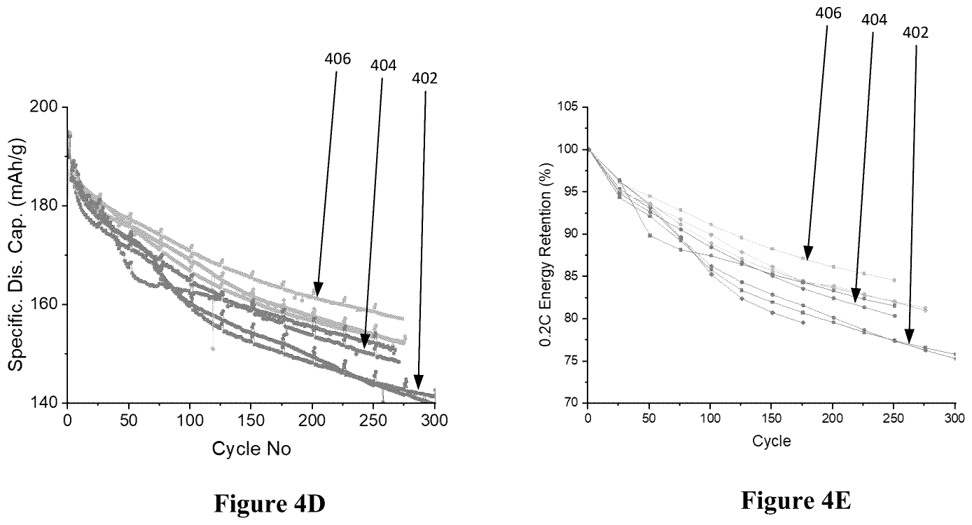

FIG. 4A depicts the energy capacity as a function of cycle count of a battery cell containing Electrolyte Fluid 3 (402), Electrolyte Fluid 4 (404), and Electrolyte Fluid 5 (406) at 0.2 discharge capacity. Electrolyte Fluids 3 (402), 4 (404), and 5 (406) contain no EC (i.e., substituting FEC for EC as a solvent). While Electrolyte Fluid 3 (402) contained PES, Electrolyte Fluid 4 (404) and Electrolyte Fluid 5 (406) removed PES. Moreover, Electrolyte Fluid 5 (406) included DFEB. By removing PES energy capacity improved as depicted by improved energy capacity of battery cells including Electrolyte Fluids 4 (404) and 5 (406) as compared to Electrolyte Fluid 3 (402). Further, addition of DFEB resulted in improved energy capacity of Electrolyte Fluid 5 (406) as compared to Electrolyte Fluid 4 (404) (as well as Electrolyte Fluid 3 (402)).

FIG. 4B depicts the energy retention as a function of cycle count of a battery cell containing Electrolyte Fluid 3 (402), Electrolyte Fluid 4 (404), and Electrolyte Fluid 5 (406) at 45° C. regular cycle capacity. Electrolyte Fluids 3 (402), 4 (404), and 5 (406) contain no EC, substituting FEC. While Electrolyte Fluid 3 (402) contained PES, Electrolyte Fluid 4 (404) and Electrolyte Fluid 5 (406) removed PES. Electrolyte Fluid 5 (406) included DFEB. By removing PES, energy retention improved as depicted by measured energy retention of Electrolyte Fluids 4 (404) and 5 (406) compared to Electrolyte Fluid 3 (402) as cycle count increases. Addition of DFEB resulted in improved energy retention of Electrolyte Fluid 5 (406) as compared to Electrolyte Fluid 4 (404) (as well as Electrolyte Fluid 3 (402)). Improvement of energy retention upon addition of DFEB may be due to promoting LiDFOB reduction on the anode.

FIG. 4C depicts the internal resistance as a function of cycle count for battery cells containing Electrolyte Fluids 3 (402), 4 (404), and 5 (406) contain no EC. Removing PES lowered the inherent RSS resistance of battery cells containing Electrolyte Fluid 4 (404) and Electrolyte Fluid 5 (406). Further, addition of DFEB in Electrolyte Fluid 5 (406) resulted in a still further reduction in RSS resistance.

FIG. 4D depicts the specific discharge capacity as a function of cycle count of a battery cell containing Electrolyte Fluid 3 (402), Electrolyte Fluid 4 (404), and Electrolyte Fluid 5 (406) during 4.52V fast charging. By removing PES, the specific discharge capacity during fast charging improved as depicted for Electrolyte Fluids 4 (404) and 5 (406) as compared to Electrolyte Fluid 3 (402). Addition of DFEB resulted in improved specific discharge capacity of Electrolyte Fluid 5 (406) as compared to Electrolyte Fluid 4 (404) (as well as Electrolyte Fluid 3 (402)).

FIG. 4E depicts the energy retention as a function of cycle count of a battery cell containing Electrolyte Fluid 3 (402), Electrolyte Fluid 4 (404), and Electrolyte Fluid 5 (406) during 4.52V fast charging. By removing PES, energy retention during fast charging improved as depicted by improved for battery cells containing Electrolyte Fluids 4 (404) and 5 (406) compared to Electrolyte Fluid 3 (402) as cycle count increases. Addition of DFEB resulted in improved energy retention of Electrolyte Fluid 5 (406) as compared to Electrolyte Fluid 4 (404) (as well as Electrolyte Fluid 3 (402)) as cycle count increases.

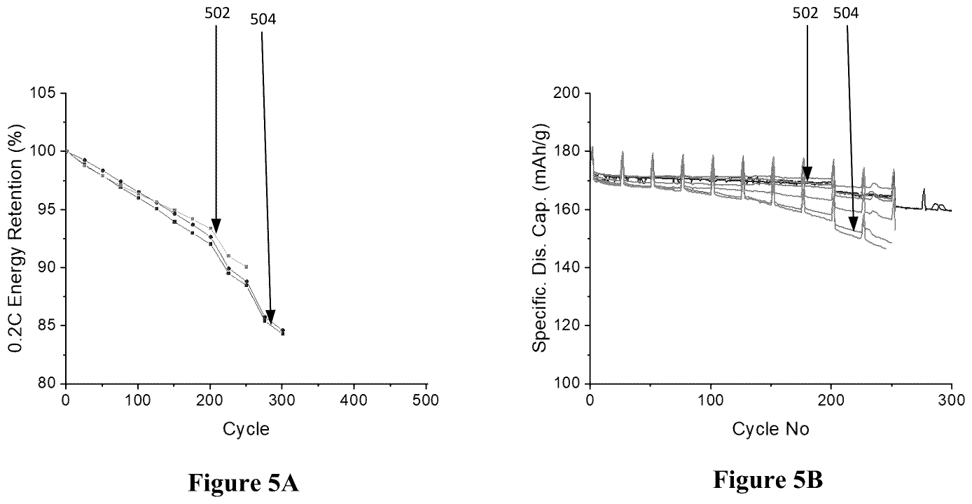

Electrolyte Fluids containing no EC in the solvent, but instead containing FEC, show improved battery performance in battery cells having silicon-containing anodes. FIGS. 5A and 5B show a comparison of a battery cell that includes 7 wt % Si in a graphite anode for Electrolyte Fluid 2 (504) (containing EC) and Electrolyte Fluid 3 (502) (containing no EC, substituting FEC). FEC-containing Electrolyte Fluid 3 (502) shows around 85% energy retention for 45° C. cycling. With reference to FIG. 5B, the battery cell shows improved specific capacity, with Electrolyte Fluid 3 (502) having a higher specific capacity as a function of cycle count than Electrolyte Fluid 2 (504).

### Example 3

Table 5 shows three electrolyte fluids. Electrolyte Fluid 3 includes PES. In Electrolyte Fluid 5 and Electrolyte Fluid 6, no PES additive is included. Electrolyte Fluid 5 includes DFEB. Electrolyte Fluid 6 includes EFPN.

TABLE 5

| UCV | | | Salt | Additive | | | | | | | |
|---|---|---|---|---|---|---|---|---|---|---|---|
| (V) | EL Code | Solvent | LiPF6 | FEC | PES | PS | LiDFOB | SN | HTCN | DFEB | EFPN |
| 4.52 | Electrolyte | FEC/EC/PC/EP/PP | 1.2M | 8 | 0.7 | 4 | 1 | 2 | 3 | | |
| | Fluid 3 | 15:0:5:30:50 | | | | | | | | | |
| 4.52 | Electrolyte | FEC/EC/PC/EP/PP | 1.2M | 8 | | 4 | 1 | 2 | 3 | 0.3 | |
| | Fluid 5 | 15:0:5:30:50 | | | | | | | | | |
| 4.52 | Electrolyte | FEC/EC/PC/EP/PP | 1.2M | 8 | | 4 | 1 | 2 | 3 | | 1 |
| | Fluid 6 | 15:0:5:30:50 | | | | | | | | | |

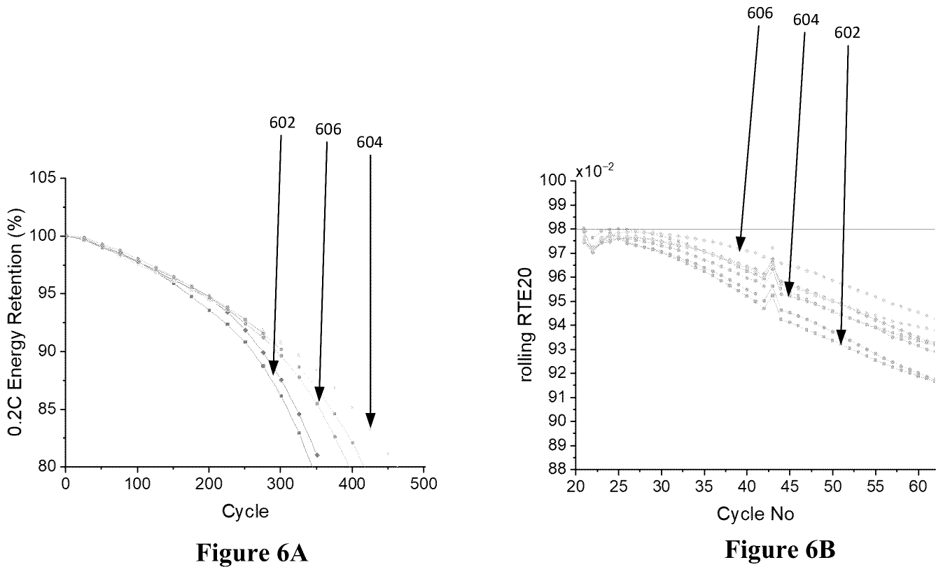

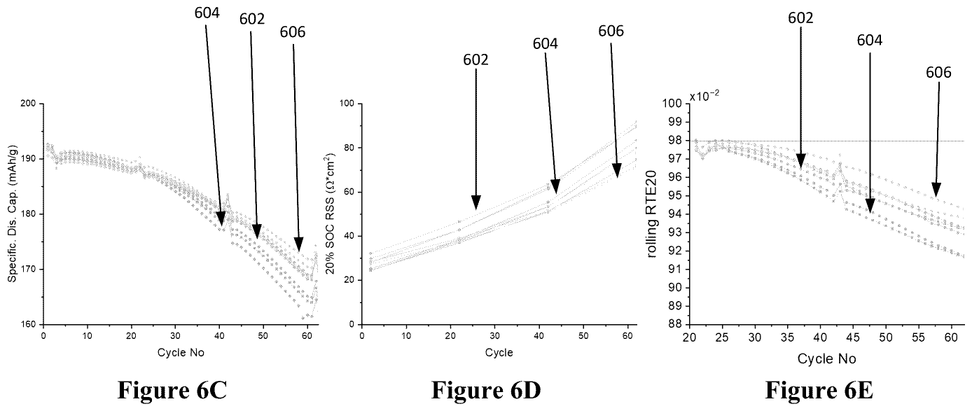

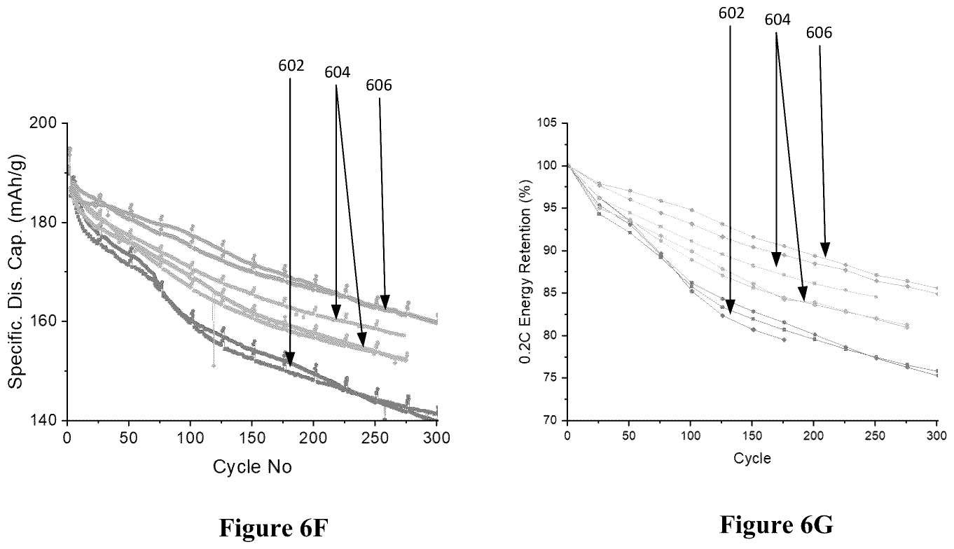

FIG. 6A depicts the energy retention as a function of cycle count of battery cells containing Electrolyte Fluid 3 (602), Electrolyte Fluid 5 (604), and Electrolyte Fluid 6 (606) at 45° C. regular cycle capacity. While Electrolyte Fluid 3 (602) contained PES, Electrolyte Fluid 5 (604) and Electrolyte Fluid 6 (606) removed PES. Electrolyte Fluids 5 (604) and 6 (606) included DFEB. Addition of DFEB resulted in improved energy retention of Electrolyte Fluid 5 (604) and 6 (606) as compared to Electrolyte Fluid 3 (602). Electrolyte Fluid 5 (604) shows improved 4.52V 45° C. regular cycling performance over Electrolyte Fluid 3 (602), but slightly reduced longevity performance. The addition of EFPN in Electrolyte Fluid 6 (606) improved cell longevity performance. Electrolyte 6 (606) stabilized the anode as compared to Electrolyte Fluid 5 (604).

FIG. 6B depicts the rolling round trip efficiency (RTE) of battery cells containing Electrolyte Fluid 3 (602), Electrolyte Fluid 5 (604), and Electrolyte Fluid 6 (606). The RTE shows ratio of the total energy output by the battery cell to the total energy input to the battery cell. Electrolyte Fluid 3 (602) containing PES has a lower RTE20. By removing PES in Electrolyte Fluids 5 (604), the RTE20 increased. By adding EFPN to the electrolyte fluid as in Electrolyte Fluids 6 (606), the RTE20 further increased.

The addition of EFPN in Electrolyte Fluid 6 (606) improves cell longevity performance. Removing PES and adding EFPN protected both cathode and anode.

FIG. 6C depicts the specific discharge capacity of battery cells containing Electrolyte Fluid 3 (602), Electrolyte Fluid 5 (604), and Electrolyte Fluid 6 (606) and operating at 4.52V and 45° C. The specific discharge capacity increased with cycle count upon removal of PES (Electrolyte Fluid 5 (604) as compared to Electrolyte Fluid 3 (602)). The specific discharge capacity further improved as a function of cycle count upon addition of EFPN (Electrolyte Fluid 6 (606) as compared to Electrolyte Fluid 5 (604)).

FIG. 6D depicts the 20% state of charge (SOC) RSS resistance of battery cells containing Electrolyte Fluid 3 (602), Electrolyte Fluid 5 (604), and Electrolyte Fluid 6 (606) and operating at 4.52V and 45° C. RSS resistance decreases with cycle count upon removal of PES (Electrolyte Fluid 5 (604) as compared to Electrolyte Fluid 3 (602)). The RSS resistance further decreases as a function of cycle count upon addition of EFPN (Electrolyte Fluid 6 (606) as compared to Electrolyte Fluid 5 (604)).

FIG. 6E depicts the rolling RTE20 of battery cells containing Electrolyte Fluid 3 (602), Electrolyte Fluid 5 (604), and Electrolyte Fluid 6 (606) operating at 4.52V and 45° C. The RTE20 shows the ratio of the total energy output by the battery cell to the total energy input to the battery cell. Electrolyte Fluid 3 (602) containing PES has a lower RTE20. By removing PES in Electrolyte Fluids 5 (604), the RTE20 increased. By adding EFPN to the electrolyte fluid as in Electrolyte Fluids 6 (606), the RTE20 further increased.

Removal of PES showed improved 4.52V 45° C. regular cycling performance but slightly reduced longevity performance. Addition of EFPN improved cell longevity performance.

FIG. 6F depicts the specific discharge capacity of battery cells containing Electrolyte Fluid 3 (602), Electrolyte Fluid 5 (604), and Electrolyte Fluid 6 (606) at 25° C. ATV-1C. The specific discharge capacity increased with cycle count upon removal of PES (Electrolyte Fluid 5 (604) as compared to Electrolyte Fluid 3 (602)). The specific discharge capacity further improved as a function of cycle count upon addition of EFPN (Electrolyte Fluid 6 (606) as compared to Electrolyte Fluid 5 (604)).

FIG. 6G depicts the 0.2 C energy retention as a function of cycle count of battery cells containing Electrolyte Fluid 3 (602), Electrolyte Fluid 5 (604), and Electrolyte Fluid 6 (606) at 25° C. ATV-1C. While Electrolyte Fluid 3 (602) contained PES, Electrolyte Fluid 5 (604) and Electrolyte Fluid 6 (606) removed PES. Electrolyte Fluids 5 (604) and 6 (606) included DFEB. Addition of DFEB resulted in improved energy retention of Electrolyte Fluid 5 (604) and 6 (606) as compared to Electrolyte Fluid 3 (602).

In addition to improved accelerated cycles per day performance (ACPD) performance, EFPN also improved fast charge cycle life while meets achieving 50% SOC charge in 15 minutes. As used herein, ACPD is a longevity test condition in which a battery is at rest 8 hours after charging and 15 minutes after discharging. To reduce testing time, the battery decreased rest time after discharge from 8 hours to 15 minute.

The electrolyte fluids described herein can be used in battery cells, including those used in electronic devices and consumer electronic products. An electronic device herein can refer to any electronic device known in the art. For example, the electronic device can be a telephone, such as a cell phone, and a land-line phone, or any communication device, such as a smart phone, including, for example an iPhone®, an electronic email sending/receiving device. The electronic device can also be an entertainment device, including a portable DVD player, DVD player, Blue-Ray disk player, video game console, music player, such as a portable music player (e.g., iPod®), etc. The electronic device can be a part of a display, such as a digital display, a TV monitor, an electronic-book reader, a portable web-browser (e.g., iPad®), watch (e.g., AppleWatch), or a computer monitor. The electronic device can also be a part of a device that provides control, such as controlling the streaming of images, videos, sounds (e.g., Apple TV®), or it can be a remote control for an electronic device. Moreover, the electronic device can be a part of a computer or its accessories, such as the hard drive tower housing or casing, laptop housing, laptop keyboard, laptop track pad, desktop keyboard, mouse, and speaker. The anode cells, lithium-metal batteries, and battery packs can also be applied to a device such as a watch or a clock.

The foregoing description, for purposes of explanation, used specific nomenclature to provide a thorough understanding of the described embodiments. However, it will be apparent to one skilled in the art that the specific details are not required to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

1. An electrolyte fluid comprising a solvent, the solvent comprising fluoroethylene carbonate (FEC) and no ethylene carbonate (EC).

2. The electrolyte fluid of claim 1, wherein the amount of FEC is 1-45 wt % of the total electrolyte solvent.

3. The electrolyte fluid of claim 1, wherein the amount of FEC is 5-25 wt % of the total electrolyte solvent.

4. The electrolyte fluid of claim 1, comprising a lithium salt selected from LiPF₆, LiBF₄, LiClO₄, LiSO₃CF₃, LiN(SO₂F)₂, LiN(SO₂CF₃)₂, LiBC₄O₈, Li[PF₃(C₂CF₅)₃], LiC(SO₂CF₃)₃, and a combination thereof.

5. The electrolyte fluid of claim 1, wherein the lithium salt comprises LiPF₆.

6. The electrolyte fluid of claim 4, wherein the lithium salt is in an amount of 0.1 M-2.0 M in the electrolyte fluid.

7. The electrolyte fluid of claim 1, further comprising an additive selected from FEC, methylene methanedisulfonate (MMDS), pro-1-ene-1, 3-sultone (PES), propane sultone (PS), lithium difluoro(oxalato)borate (LiDFOB), succinonitrile (SN), 1,3,6-hexanetricarbonitrile (HTCN), and a combination thereof.

8. The electrolyte fluid of claim 1, comprising 0.2-2.0 wt % prop-1-ene-1, 3-sultone (PES).

9. The electrolyte fluid of claim 8, comprising one or more of:
2.0-20.0 wt % FEC;
0-5.0 wt % MMDS;
0.05-12.0 wt % PS;
0.1-5.0 wt % LiDFOB;
0.2-6 wt % wt % SN;
0.3-15 wt % HTCN; and
1.0-3.0 wt % LiBF₄.

10. The electrolyte fluid of claim 1, comprising 0 wt % PES.

11. The electrolyte fluid of claim 10, comprising one or more of:
2.0-20.0 wt % FEC;
0-5.0 wt % MMDS;
0.05-12.0 wt % PS;
0.1-5.0 wt % LiDFOB;
0.2-6 wt % wt % SN;
0.3-15 wt % HTCN; and
1.0-3.0 wt % LiBF₄.

12. The electrolyte fluid of claim 10, comprising DFEB.

13. The electrolyte fluid of claim 12, wherein DFEB is in an amount of 0.03-10 wt %.

14. The electrolyte fluid of claim 13, comprising FEC, MMDS, PS, LiDFOB, SN, HTCN and LiBF₄.

15. The electrolyte fluid of claim 11, comprising FEC, MMDS, PS, LiDFOB, SN, HTCN and LiBF₄.

16. A battery cell comprising:
a cathode comprising a cathode active material disposed on a cathode current collector;
an anode comprising an anode active material disposed on an anode current collector, the anode oriented towards the cathode such that the anode active material faces the cathode active material;
a separator disposed between the cathode active material and the anode active material; and
an electrolyte fluid of claim 1.

17. The battery cell of claim 16, wherein the anode active material is selected from graphite, silicon, and a combination thereof.

18. The battery cell of claim 16, wherein formula (I) has the chemical structure 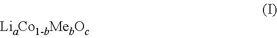
wherein Me is selected from Na, Si, S, Al, K, V, Cr, Fe, Cu, Zn, Mn, Ni, Zr, La, Ce, Y, Mo, Sn, Ag, Nb, Nu, Ca, Ti, Mg, and a combination thereof,
wherein 0.95≤a≤1.05;
wherein 0<b≤0.15; and
wherein 1.95≤c≤2.05.

19. The battery cell of claim 18, wherein Me is Mn and Al.

20. The battery cell of claim 16, wherein the separator polyethylene (PE), polypropylene (PP), polyamide (PA), polytetrafluoroethylene (PTFE), polyvinyl chloride (PVC), polyester, and polyvinylidene difluoride (Pad), or a combination thereof.
